(19) United States
(12) Patent Application Publication
(10) Pub. No.: US 2023/0366278 A1
(43) Pub. Date: Nov. 16, 2023

(54) TUBULAR MANAGEMENT SYSTEM ERROR DETECTION

(71) Applicant: Nabors Drilling Technologies USA, Inc., Houston, TX (US)

(72) Inventor: Pradeep ANNAIYAPPA, Houston, TX (US)

(21) Appl. No.: 18/316,313

(22) Filed: May 12, 2023

Related U.S. Application Data
(60) Provisional application No. 63/364,736, filed on May 16, 2022.

(51) Int. Cl. E21B 19/16; E21B 19/15; G06T 7/73

(52) U.S. Cl. CPC E21B 19/165; E21B 19/155; G06T 7/73; G06T 2207/20081

(57) ABSTRACT

A method for conducting subterranean operations can include engaging a tubular with a pipe handler, moving the tubular with the pipe handler to a new location, disengaging from the tubular at the new location, determining, via a rig controller, an estimated location of the tubular based on the new location at which the pipe handler disengaged from the tubular, determining, via a machine learning module of the rig controller and one or more imaging sensors, a deviation from the estimated location of the tubular.

### CROSS-REFERENCE TO RELATED APPLICATION(S)

This application claims priority under 35 U.S.C. § 119(e) to U.S. Provisional Application No. 63/364,736, entitled “TUBULAR MANAGEMENT SYSTEM ERROR DETECTION,” by Pradeep ANNAIYAPPA, filed May 16, 2022, which is assigned to the current assignee hereof and incorporated herein by reference in its entirety.

### FIELD OF THE DISCLOSURE

The present invention relates, in general, to the field of drilling and processing of wells. More particularly, present embodiments relate to a system and method for managing tubulars on a rig during subterranean operations, tracking the tubulars during the subterranean operations, and logging usage data for the tubulars during the subterranean operations.

### BACKGROUND

Robots can reduce safety risks to personnel in various subterranean operations by operating in hazardous conditions and/or in dangerous locations, such as handling tubulars to make-up or break-up tubular strings. Tubular (or pipe) handling robots, such as Iron Roughnecks, automated catwalks, tubular elevators, and pipe handlers, can operate on and/or near a rig floor. For example, robotic systems can manage (or assist in management of) tubular (or other equipment) as they are manipulated on the rig (e.g., between storage areas and a wellbore). However, for the robotic systems to operate efficiently, such as when manipulating tubulars on the rig, the robotic systems need to know the actual location of the equipment being managed (e.g., tubulars, pipe handlers, etc.) to prevent them from having to hunt for the equipment before engaging or interfacing with the equipment. Therefore, improvements in robotic systems are continually needed.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for conducting subterranean operations. The method also includes engaging a tubular with a pipe handler; moving the tubular with the pipe handler to a new location; disengaging from the tubular at the new location; determining, via a rig controller, an estimated location of the tubular based on the new location at which the pipe handler disengaged from the tubular; and determining, via a machine learning module of the rig controller, a deviation parameter of the tubular by determining a deviation from the estimated location based on processing collected images from one or more imaging sensors that contain the tubular. Other embodiments of this aspect include corresponding computer systems, apparatus, and computer programs recorded on one or more computer storage devices, each configured to perform the actions of the methods.

One general aspect includes a method for conducting a subterranean operation. The method also includes retrieving a known length of a tubular from a unique data record in a first database, where the unique data record is associated with a unique record identification (ID) of the tubular; detecting, via an imaging sensor, a location of a first detectable feature of a tubular string; connecting the tubular to the tubular string; lowering the tubular string along with the tubular a pre-determined distance into a wellbore; determining, via a rig controller, an estimated location of a second detectable feature of the tubular by adding the known length to the location of the first detectable feature and subtracting the pre-determined distance; detecting, via a machine learning module, a deviation of the second detectable feature from the estimated location; and storing the deviation as a deviation parameter in a second database associated with the unique record ID of the tubular. Other embodiments of this aspect include corresponding computer systems, apparatus, and computer programs recorded on one or more computer storage devices, each configured to perform the actions of the methods.

One general aspect includes a method for conducting a subterranean operation. The method also includes retrieving a known length of a first tubular from a unique data record in a first database, where the unique data record is associated with a unique record identification (ID) of the first tubular; detecting, via an imaging sensor, a location of a first detectable feature of the first tubular; raising a tubular string a pre-determined distance out of a wellbore, where the first tubular is connected at a top of the tubular string; determining, via a rig controller, an estimated location of a second detectable feature of the tubular string by adding the pre-determined distance to the location of the first detectable feature and subtracting the known length; disconnecting the first tubular from the tubular string; detecting, via a machine learning module, a deviation from the estimated location of the second detectable feature; and storing the deviation as a deviation parameter in a second database associated with a unique record ID of a second tubular that is connected at the top of the tubular string after the first tubular is removed from the tubular string. Other embodiments of this aspect include corresponding computer systems, apparatus, and computer programs recorded on one or more computer storage devices, each configured to perform the actions of the methods.

### BRIEF DESCRIPTION OF THE DRAWINGS

These and other features, aspects, and advantages of present embodiments will become better understood when the following detailed description is read with reference to the accompanying drawings in which like characters represent like parts throughout the drawings, wherein:

FIG. 1 is a representative view of a rig used to perform subterranean operations, in accordance with certain embodiments;

FIG. 2 is a representative functional block diagram of a rig controller for controlling the tubular management system and performing machine learning for tubular handling and other controls, in accordance with certain embodiments;

FIG. 3B is a representative graphical user interface used to interact with an operator or user to manage tubulars and display a pipe tally length, in accordance with certain embodiments;

FIGS. 3A, 4, 5, and 6 are representative functional block diagrams of a system in various stages of running a tubular string into a wellbore, in accordance with certain embodiments;

FIG. 7 is a representative perspective view of rig equipment, including a retention feature, that is used during subterranean operations (e.g., drilling a wellbore), in accordance with certain embodiments;

FIG. 8 is a representative perspective view of an example of a retention feature used during subterranean operations, in accordance with certain embodiments;

FIG. 9 is a representative perspective view of the retention feature of FIG. 8 with a housing of the retention feature open to reveal grippers inside, in accordance with certain embodiments; and

FIGS. 10, 11, and 12 are representative functional block diagrams of at least a portion of a tubular management system that can be used to detect errors in management of a tubular, in accordance with certain embodiments.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

The use of the word “about”, “approximately”, or “substantially” is intended to mean that a value of a parameter is close to a stated value or position. However, minor differences may prevent the values or positions from being exactly as stated. Thus, differences of up to ten percent (10%) for the value are reasonable differences from the ideal goal of exactly as described. A significant difference can be when the difference is greater than ten percent (10%).

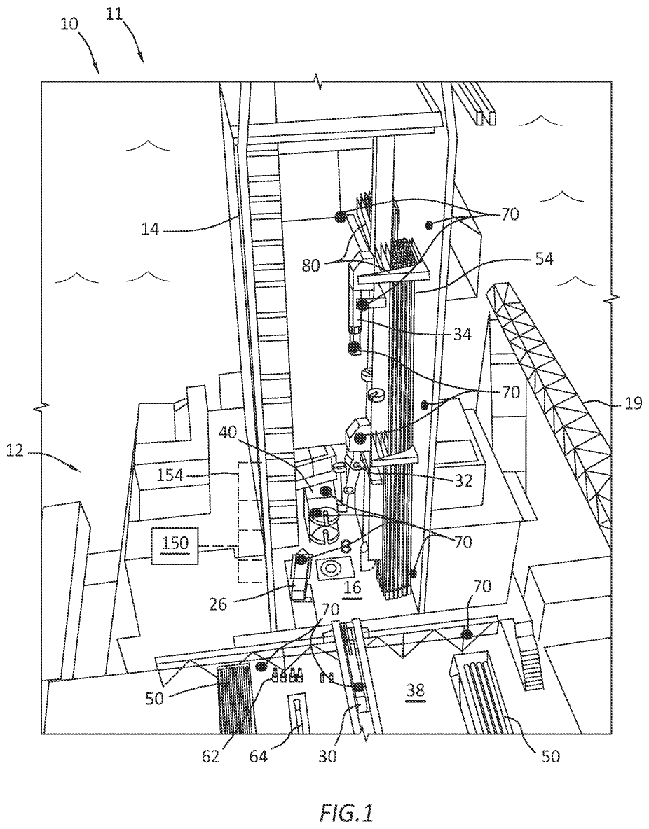

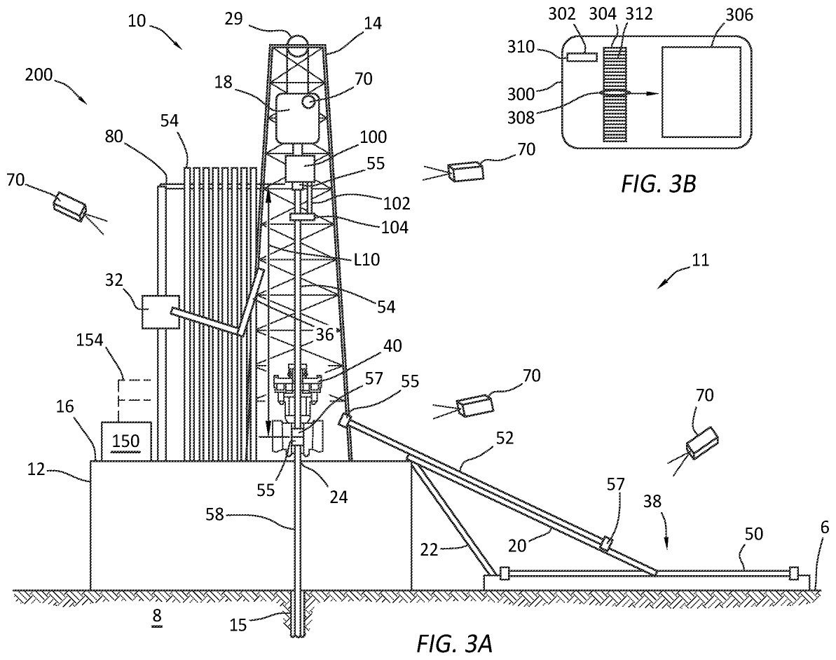

As used herein, “tubular” refers to an elongated cylindrical tube and can include any of the tubulars manipulated around a rig, such as tubular segments, tubular stands, tubulars, and tubular string, but not limited to the tubulars shown in FIGS. 1 and 3. Therefore, in this disclosure, “tubular” is synonymous with “tubular segment,” “tubular stand,” and “tubular string,” as well as “pipe,” “pipe segment,” “pipe stand,” “pipe string,” “casing,” “casing segment,” or “casing string.”

FIG. 1 is a representative view of a rig 10 at a rig site 11 that can be used to perform subterranean operations. The rig 10 is shown as an offshore rig, but it should be understood that the principles of this disclosure are equally applicable to onshore rigs as well. The example rig 10 can include a platform 12 with a derrick 14 extending above the platform 12 from the rig floor 16. The platform 12 and derrick 14 provide the general super structure of the rig 10 from which the rig equipment is supported. The rig 10 can include a horizontal storage area 38, pipe handlers 30, 32, 34, a drill floor robot 26, an iron roughneck 40, a crane 19, fingerboard storage 80, and a plurality of sensors 70 distributed at various locations on the rig 10. The sensors 70 can be any type of sensors that can detect various characteristics of the tubular being used on the rig 10.

The sensors 70 can be two dimensional (2D) cameras, three dimensional (3D) cameras, infrared cameras, closed circuit television (CCTV) cameras, X-ray sensors, light detection and ranging (LiDAR) sensors, proximity sensors, strain gauges, torque sensors, accelerometers, optical sensors, laser sensors, physical contact sensors, contact sensors with encoders, audio sensors, pressure sensors, temperature sensors, environmental sensors, gas sensors, liquid sensors, or other suitable sensors for detecting characteristics of the rig environment or tubulars. The sensors 70, as well as other rig environment on the rig 10, can be communicatively coupled to a rig controller 150 via a network 154, with the network 154 being wired or wirelessly connected to the sensors 70 or rig environment.

The sensors 70 can be disposed on stationary locations (such as on or above the horizontal storage area 38, at various points along the fingerboard storage 80, on the derrick 14, on the platform 12, etc.). The sensors 70 can also be disposed on robotic equipment, such as the drill floor robot 26, the iron roughneck 40, the pipe handlers 30, 32, 34, a top drive 18 (not shown), and the crane 19. Some of the tubulars that can be used during subterranean operations is shown in the horizontal storage area 38 and the fingerboard storage 80, such as the tubulars 50, the tools 62, the bottom hole assembly (BHA) 64, and tubulars 54. The tubulars 50, 54 can include drilling tubular segments, casing tubular segments, and tubular stands that are made up of multiple tubular segments. The tools 62 can include centralizers, subs, slips, subs with sensors, adapters, etc. The BHA 64 can include drill collars, instrumentation, and a drill bit.

Receiving the tubulars at the rig site 11, the controller 150 can use one or more sensors 70 (e.g. one or more cameras, one or more scanners, etc.) to identify characteristics of the tubulars, such as dimension (e.g. lengths, diameters, spacings, tool joints, etc.), linearity of the tubulars, detectable features on the tubulars (bar codes, Q-codes, other machine readable patterns, gradient patterns, color patterns, shoulders of the tubulars, physical features of the tubulars, etc.), and a type of the tubular (e.g. tubular stand, drill pipe, casing segment, drill collar, BHA, tool, etc.).

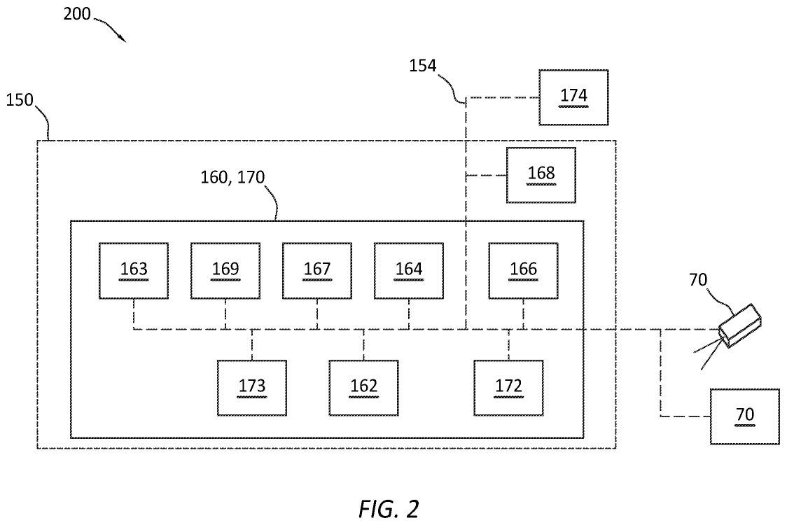

The tubular management system 200 (FIG. 2) can create a unique data record for each tubular 50, 54 to be managed at the rig site 11. The information contained in the unique data record can be created from data received for each tubular 50 from a manufacturer, an operator, a remote controller, lab tests, data books, sensors, or combinations thereof. The tubular management system 200 can use the data to check characteristics of the tubular 50, 54 when the tubular 50, 54 is moved about the rig 10 or rig site 11, such as comparing detected characteristics to manufacturers data. The characteristics of the tubular 50, 54 can include a three-dimensional (3D) location and 3D orientation on the rig 10, inner and outer diameters along the tubular, weight of the tubular, a known length of the tubular, a location of one or more detectable features on the tubular, box end 55 and pin end 57 thread lengths of the tubular, tool joint lengths of the tubular, and linearity (or non-linearity) or the tubular.

The unique data record can be created when the tubular arrives at the well site 11. The tubular management system 200 can give each data record a unique record identification (ID) that is associated with a respective tubular 50, 54. The unique record ID can be used by the tubular management system 200 to associate additional data about the respective tubular and store the additional data (e.g., historical data including usage data, degradation data, expected end of life data, life cycle data, etc.) in the unique data record that is associated with the unique record ID. The complete record of a particular tubular 50, 54 (or at least a portion of the unique data record) can be retrieved at any time by providing the unique record ID to the tubular management system 200 via the HMI 168, another input device, or another controller and requesting a report of the data associated with the unique record ID. Known database techniques can be used to build and manage the database of the unique data records 169, so these database techniques will not be discussed in more detail in this disclosure.

The data record for each tubular 50 (which can also refer to a tubular 52 or a tubular 54) can include (but is not limited to) characteristics of the tubular 50 such as 1) tubular contact zones that include positions to grip the tubular, 2) tubular non-contact zones that are positions to not grip the tubular, 3) center of gravity, 4) diameters along the tubular, 5) shape of the tubular, 6) weight of the tubular, 7) dimensions of the tubular, 8) type of the tubular (e.g., tool, BHA, drill pipe, casing, drill collar, etc.), 9) usage log of the tubular, 10) degradation parameters of the tubular (e.g., wear locations, damaged locations, etc.), 11) manufacturing details of the tubular (e.g. materials, life cycles, tolerances, specifications, etc.), 12) longitudinal linearity of the tubular, 13) historical data of the tubular, 14) 3D location of each tubular 50 including locations of the pin and box ends of the tubular, 15) 3D locations of the contact or non-contact zones of the tubulars 50, or 16) combinations thereof. Some characteristics considered to be historical data can also be seen as pre-determined characteristics, since even previously acquired historical data collected during subterranean operations can be used to compare to more recently collected characteristics during subterranean operations to detect trends or detect changes from one collection time to another. Other pre-determined characteristics can be received from sources other than scanning the tubular via one or more sensors, such as manufacturer's data.

Referring to FIG. 2, the tubular management system 200 can include a rig controller 150 with one or more local processing units 160 that can be locally positioned with either or both the top drive 18 and tubular running tool 100 or one or more remote processing units 170. The processing unit 160, 170 can be remotely positioned from either or both the top drive 18 and tubular running tool 100. Each processing unit 160, 170 can include one or more processors 162, 172 (e.g., microprocessors, programmable logic arrays, programmable logic devices, etc.), non-transitory memory storage 164, peripheral interface 166, human machine interface (HMI) device(s) 168, and possibly a remote telemetry interface 174 for internet communication or satellite network communication. The HMI devices 168 can include a touchscreen, a laptop, a desktop computer, a workstation, or wearables (e.g., smart phone, tablet, etc.). These components of the rig controller 150 can be communicatively coupled together via one or more networks 154, which can be wired or wireless networks.

The processors 162, 172 can be configured to read instructions from one or more non-transitory memory storage devices 164 and execute those instructions to perform any of the operations described in this disclosure. The processing units 160, 170 can also include databases 167, 169 that can store the unique data records including the associated information for each unique data record. The processing units 160, 170 can also include a database 163 for storing images used to train a machine learning module (MLM) 173 of the processing units 160, 170 as well as storing collected images from various sensors 70. The collected images can be presented to the MLM 173 to determine errors in locations of tubulars 50, tubulars segments 54 in the tubular string 58, or pin or box ends of the tubulars 50, 54, including tubular joints in the tubular string 58.

The database 169 can store estimated information for all unique data records, such as where a pipe handler 30, 32, 34 disengages from a tubular 50, which can establish an estimated 3D orientation and location of the tubular 50. The tubular management system 200 can detect errors in the estimated 3D orientation and location of the tubular 50 via the MLM 173 and store these errors related to the unique data record in an error database 167. For example, the error can be a deviation from the estimated location based on the MLM 173 processing of collected images, via machine learning, from the one or more sensors 70 based on training images processed by the MLM 173 prior to receiving the collected images.

For example, the error can be a deviation from the estimated location based on the MLM 173 processing of collected images as the estimated location changes, such as when a tubular string 58 is being tripped in or tripped out of the wellbore 15. The MLM 173 can be taught what to expect in the collected images of a tubular string 58 or a tubular 50 or a portion of the rig 10 by processing the training images and can continue to learn based on the collected images. The MLM 173 can also be taught to calculate a confidence score for the error, and report the confidence score to the rig controller 150 or to an operator via the HMI devices 168 or store the confidence score in the error database 167 associated with the appropriate unique record ID.

In some instances, the MLM 173 may calculate an error for one or more time intervals as a tubular string 58 is being tripped into or out of the wellbore 15. As the MLM 173 continues to calculate the error for a tubular segment 54 in the tubular string 58 (or a pin end of the tubular segment 54, or a box end of the tubular segment 54, or a non-contact zone of the tubular segment 54, etc.) as the tubular string 58 is moving, if the sensor data provides accurate data regarding the tubular 54, then the calculated error should remain substantially constant. However, if the sensor data provides intermittent data (such as imagery during low light events, imagery during interference events, etc.), then the MLM 173 may calculate an error that changes over time, such as erratically, intermittently, or gradually. The amount of change during a pre-determined time interval or a frequency of change during the pre-determined time interval can indicate that the calculated error may be incorrect and, in some cases, not relied upon, due to the incorrectness of the calculated error.

The MLM 173 can indicate a confidence in the correctness (or a level of incorrectness) of the calculated error by calculating a confidence score for the calculated error. The MLM 173 can determine the confidence score based on the stability of the calculated error over a pre-determined period of time (e.g., 5 seconds, 4 seconds, 3 seconds, 2 seconds, 1 second, etc.). The error can be calculated multiple times during the pre-determined period of time and if the calculated errors are substantially equal to each other, then the MLM 173 can set the confidence score for the calculated errors to be high, meaning that the sensed data continues to provide data that results in a steady calculated error. If the calculated errors are significantly different from one or more of the others, then the MLM 173 can set the confidence score for the calculated errors to be anywhere from high to low, with low meaning that the sensed data continues to provide data that results in an erratic or changing calculated error. The amount of change and the rate of change of the error during the pre-determined period of time can affect the confidence score of the calculated error. Higher amounts of change or higher rates of change can lower the confidence score and lower amounts of change or lower rates of change can raise the confidence score.

In the case where the tubular 50 is not moving during the pre-determined period of time, then the multiple calculations of the error during the pre-determined period of time has fewer factors that can cause the calculated error to change during the pre-determined period of time. However, changes of the calculated error may still occur, and the MLM 173 can determine a confidence score for the calculated error based on the changes.

In a non-limiting embodiment, the confidence level can still be high even when the calculated error has changed. For example, if the calculated error has not significantly changed during a first pre-determined time period and then changes during a second pre-determined time period, then the MLM 173 may indicate that the confidence score is high even since the calculate error of the first pre-determined time period is different than the calculated error of the second pre-determined time period. This can indicate that the sensor data is valid and that the sensors are detecting actual movement of tubular 50. Therefore, a high confidence score with a calculated error that has changed can indicate a failure of the equipment, such as slippage of the tubular string 58 due to wear of the die in the retention feature 71, movement of the tubular 50 after it had come to rest in the vertical storage, etc. Therefore, when the calculated error remains substantially constant during a first (or multiple) time periods and changes in a second (or other) time period, then equipment failures can be detected and indicated.

For another example, the error can be seen as a slippage of the tubular string 58 in the wellbore 15 after the top drive 18 releases the tubular string 58, such as to begin the process of adding another tubular 50 to the tubular string 58. When the top drive 18 lowers the tubular string 58 to a desired height above the rig floor 16, the retention feature 71 (e.g., slips) can engage the tubular string 58 and receive the load of the tubular string 58 from the top drive 18. When the top drive 18 releases the tubular string 58 to the retention feature 71, the weight of the tubular string 58 and possibly wear of the retention feature 71 may cause or allow the tubular string 58 to move down after the top drive 18 releases it. The downward (or axial) movement of the tubular string 58 after the top drive 18 releases the tubular string 58 can be seen as a deviation from the estimated location of the tubular string 58.

Therefore, a pipe handler 30, 32, 34 can engage the tubular string 58 or maneuver a tubular 50 into engagement with the tubular string 58 based on the estimated location and the deviation from the estimated location. The deviation can be communicated to the pipe handler which can use the deviation to correctly engage the tubular string 58. The estimated location of the tubular 50 or tubular string 58 can be associated with a unique record ID, where the estimated value is stored in a unique data record entry in the database 169 and the deviation is stored in a unique entry in the database 167.

Additionally, a confidence score of the deviation can be stored in a unique entry in the database 167. The confidence score can be used to alert the rig controller 150 or the operator to the confidence in the accuracy of the deviation. If the confidence level is low, then the rig controller 150 or the operator can determine to disregard the deviation value and proceed without using the calculated error to control positioning of the pipe handlers or other rig equipment.

By keeping the deviation parameters separate from the estimated location (even though they may be stored in the same transitory memory, but are separate values), the estimated location for the unique record ID is preserved without modification, and the deviation parameters are used to identify the deviation from the estimated location (such as an estimated 3D orientation and location) of the tubular 50 associated with the unique record ID. It should be understood that the unique data records databases 167, 169 can be combined with the non-transitory memory storage devices 164 or can be separate from but communicatively coupled to the memory devices 164. If the deviation parameters are above a pre-determined value, then corrective actions can be initiated by the rig personnel or the rig controller 150.

Training images can be stored in the database 163 and used to train the MLM 173 or the training images can be input directly to the MLM 173 without first being stored in the database 163. The MLM 173 can receive the images and interpret the contents of the images and the relative position of tubulars 50 (or tubular string 58) in the training images. As in known machine learning techniques, the more training images provided to the MLM 173 prior to the MLM 173 being used to provide an evaluation of a collected image, the more precise the prediction of the deviation parameters can be. Copies of training images can be used to increase the number of training images processed by the MLM 173 prior to evaluation of collected images, without requiring actual collection of additional training images to improve accuracy of the MLM 173.

A peripheral interface 166 can be used by the rig controller 150 to receive sensor data from around the rig such as from the sensors 70 which can collect data on various equipment at the rig site 11, such as the iron roughneck 40, the pipe handlers 30, 32, 34, the catwalk 20, the top drive 18, tubular running tool 100, the drill floor robot 26, tubulars 50, 52, 54, etc. The peripheral interface 166 can also be used by the rig controller 150 to send commands to the iron roughneck 40, the pipe handlers 30, 32, 34, the catwalk 20, the top drive 18, tubular running tool 100, the drill floor robot 26, etc. to perform subterranean operations such as tripping in the tubular string 58 into the wellbore 15. The peripheral interface 166 can also be configured to communicate with one or more sensors 70, which can be used to capture images of tubulars 50 (or tubular string 58) or perform laser ranging (such as with LiDAR or time-of-flight cameras) and transfer the images or the ranging data to the processing units for determining (or verifying) characteristic(s) of the tubulars, such as length, diameters, tool joint lengths, thread length, actual location, actual orientation, etc.

FIG. 3A is a representative functional block diagram of a rig 10 at a rig site 11 for managing tubulars to run a tubular string 58 into or out of the wellbore 15 formed through the surface 6 and into the subterranean formation 8. The rig 10 can include a platform 12 with a derrick 14 extending from a rig floor 16. The derrick 14 can provide structural support for the top drive 18 and a crown block 29. The crown block 29 can be used to raise and lower the top drive 18. A tubular running tool 100 can be coupled to the top drive 18 to facilitate moving tubular segments from a catwalk 20 (or other pipe handler 30, 32, 34) to well center 24 for connection to a stump 60 (i.e., portion of tubular string 58 protruding above the rig floor 16) at the well center 24.

For tripping in, the tubular string 58 is run into the wellbore 15 by successively adding additional tubulars 54 to the top end (i.e., stump 60) of the tubular string 58 to further extend the tubular string 58 into the wellbore 15. Therefore, tubulars 50 positioned in a horizontal storage area 38 can be presented to the rig floor 16 via a catwalk 20 as it moves along a V-door ramp 22 (e.g., tubular 52). It should be understood that any other tubular manipulation systems (such as pipe handler 32 with an articulating arm 36) can be used to deliver tubulars from a horizontal tubular storage area 38 or vertical tubular storage area 80 to the rig floor 16 so the top drive 18 (and possibly a tubular running tool 100) can engage the tubular 52 and move it to well center 24. Therefore, this disclosure is not limited to the catwalk type pipe handler.

It should be understood that the tubular running tool 100 is not required for managing tubulars 54 at well center 24. The running tool 100 is more applicable to running casing type tubulars 54, as where an elevator (not shown) can be linked to the tubular running tool 100 to engage the tubular 54, with the quill (not shown) of the top drive 18 engaged with the top of the tubular running tool 100 to rotate, raise, and lower the tubular 54. Alternatively, the top drive 18 with a pair of coupled links can be used to run drill pipe and other tubulars 54 without using a tubular running tool 100. Whether the top drive 18 with an elevator, or a top drive 18 with a running tool 100, or other pipe handlers are used to add or remove tubulars 54 from the tubular string 58, the methods and systems described in this disclosure to manage tubulars on the rig 10 and at the rig site 11 are still applicable regardless of how the tubulars 54 are handled.

For tripping out, the tubular string 58 is run out of the wellbore 15 by successively removing tubulars 54 from the top end of the tubular string 58 to further retract the tubular string 58 from the wellbore 15. These tubulars segments 54 removed from the tubular string 58 can be moved away from the well center 24 and stored in a horizontal tubular storage area 38 or vertical tubular storage area 80 or removed from the rig site 11. It should be understood that any other tubular manipulation systems can be used to remove tubulars from well center 24 and move the tubulars to a horizontal tubular storage area 38 or vertical tubular storage area 80.

Whether tripping in or tripping out, it is advantageous to understand how far down into the wellbore 15 the tubular string 58 extends from the rig floor 16. This can be determined by keeping a running tally of the tubulars 54 that make up the tubular string 58. From the running tally (also referred to as “pipe tally length”), a total length of the tubular string 58 can be calculated by adding up all the lengths of the tubulars 54 that remain in the tubular string 58 to maintain the pipe tally length. This can be referred to as a pipe tally length which is a running total of the overall length of the tubular string 58 based on the known lengths L10 of the tubulars 54 that make up the tubular string 58 at any point in time. The pipe tally length 310 (representatively illustrated in FIG. 3B as being displayed in window 302 of the display 300) is updated in real-time as the tubular string 58 is tripped into or tripped out of the wellbore 15. When a tubular 54 is added to the tubular string 58, the new tubular 54 is added to the pipe tally 312 and the known length L10 of the tubular 54 is added to the pipe tally length 310. When a tubular 54 is removed from the tubular string 58, the tubular 54 is removed from the pipe tally 312 and the known length L10 of the tubular 54 is deducted from the pipe tally length 310. Knowing the location of the tubular string 58 relative to the rig 10 can allow the pipe tally length 310 to be used to determine the distance into the wellbore 15 to which the tubular string 58 is extended even while the tubular 58 is being raised from or lowered into the wellbore 15. The pipe tally length 310 along with the calculated error and the position of the top drive can be used to calculate the distance into the wellbore 15 as well as the location of the tubular joints in the tubular string 58 as the tubular string 58 is being moved.

In the case of running tubulars 54, such as drill pipe, into or out of the wellbore 15, the length from the shoulder of the box end 55 to the shoulder of the pin end 57 can represent the overall length of the drill tubular 54 minus the length of the tapered threads on the pin end 57, which can be referred to as the known length L10 of the drill tubular 54. The shoulders of the box and pin ends 55, 57 of the tubular are seen as the ends of the drill tubular 54 that are configured to abut a shoulder of an adjacent drill tubular 54 in the tubular string 58. The threads on the pin end 57 will be threaded into a box end 55 of an adjacent drill tubular 54 in the tubular string 58, therefore, since the thread length overlaps the box end 55, then the threads do not affect the pipe tally length 310. Therefore, when adding a drill tubular 54 to the tubular string 58, the known length L10 is the length from the pin end shoulder to the box end shoulder of the drill tubular 54 and this length is added to the pipe tally length 310. Conversely, when removing a drill tubular 54 from the tubular string 58, the known length L10 is subtracted from the pipe tally length 310. This known length L10 is added or subtracted as needed to keep the pipe tally length 310 up to date as the tubular string 58 is tripped out of or into the wellbore 15.

In the case of running tubulars 54, such as casing segments, into or out of the wellbore 15, casing tubulars 54 may be coupled together via a casing collar 48 (or coupling 48, see FIG. 14). The casing tubular 54 may have both ends threaded with external threads so ends of adjacent casing tubulars 54 are threaded into the casing collar 48 from opposite ends, with the casing collar having internal threads that engage the external threads of two adjacent casing tubulars 54. When running casing tubulars 54 into the wellbore 15, the top end of the tubular string 58 can have a casing collar threaded onto the top end forming a box end 55 of the casing tubular 54. The next casing tubular 54 can be aligned with the tubular string 58 and threaded into the casing collar. When the casing joint is torqued to meet the torque requirements, a gap may exist between the top end of the tubular string 58 and the newly added casing tubular 54. Therefore, the known length L10 of the casing tubular 54 can include the overall length of the casing tubular 54 measured from each longitudinal end (also referred to as a shoulder) of the casing tubular 54 plus the gap between the tubular string 58 and the newly added casing tubular 54. The gap can be filled by a torque ring that can be used to provide increased strength of the torqued casing joint. This known length L10 is added or subtracted as needed to keep the pipe tally length 310 up to date as the tubular string 58 is tripped out of or into the wellbore 15.

FIG. 3B is a representative graphical user interface (GUI) 300 used to interact with an operator or user to manage tubulars 50, 52, 54 and display a pipe tally length 310 when desired by the operator or user. The GUI 300 can include a display communicatively coupled to the controller 150 and can be used to display the pipe tally length 310 and a list of tubulars 54 included in the tubular string 58. A pipe tally window 304 can be used to display the pipe tally 312, which includes a list of the unique record ID of each tubular 54 in order of its location in the tubular string 58. If the user desired to display the full data for an individual tubular 54, then the operator or user can select (such as indicated by selection 308) the particular unique record ID from the pipe tally 312 and the information related to the selected tubular 54 can be displayed in one or more display windows 306.

FIG. 3A shows a tubular 54 that has been moved from the tubular location 50, up the catwalk 20 at tubular location 52, and to a vertically oriented location at well center 24. The tubular 54 has been coupled to the tubular running tool 100 at its box end 55 and the pin end 57 of the tubular 54 has been connected to the box end 55 of the tubular string 58. The known length L10 of the tubular 54 has previously been determined and verified via sensors 70 (including ranging sensors or imaging sensors) and possibly historical data. The characteristics of the tubular 54 being added to the tubular string 58 can be captured in the unique data record for the particular tubular 54, with the particular tubular 54 being assigned a unique record ID. The unique data record can include the known length L10 of the tubular 54 which can be used to update the pipe tally length 310 when the particular tubular 54 is connected to the tubular string 58 at well center 24 or to be disconnected from the tubular string 58. The tubular management system 200 can update the pipe tally length 310 when the tubular 54 is connected to the tubular string 58, but not yet inserted into the wellbore 15. The tubular management system 200 can update the pipe tally length 310 when the tubular 54 is disconnected from the tubular string 58.

The tubular running tool 100 can include a link pair 102 rotationally coupled to the tubular running tool 100 at one end and coupled to an elevator clamp 104 at an opposite end. It should be understood that the link pair 102 can be rotationally coupled to the top drive 18 when the tubular running tool 100 is not used. The elevator clamp 104 can be used to clamp around a tubular 52 and lift the tubular 52 to a vertical orientation as the top drive 18 is raised by the crown block 29. A rig controller 150 can include one or more processing units communicatively coupled, via a network 154 to the top drive 18 and tubular running tool 100 (or elevator attached to the top drive). One or more of the processing units can be local to or remotely located from either or both of the top drive 18 and tubular running tool 100 (or elevator attached to the top drive). The rig controller 150 can be communicatively coupled to the imaging sensors 70 for collecting imagery of tubulars 50, 52, 54, 58 supporting the subterranean operations of the rig 10.

At least one sensor 70 on the top drive 18 can be used to measure, detect, or determine the vertical height of the top drive 18 above the rig floor 16. Therefore, when tripping in, the tubular management system 200 knows how far, based on the known length L10 of the newly added tubular 54, the top drive 18 should lower the tubular string 58 to again have a desired stump 60 protruding from the rig floor 16, where the top drive 18 can again vertically position a new tubular 54 above the stump 60 to repeat the addition procedure for another tubular 54. When tripping out of the wellbore 15, the tubular management system 200 knows how far, based on the known length of the tubular 54, the top drive 18 should raise the tubular string 58 from the wellbore 15, such that when the tubular 54 is removed from the tubular string 58 and the pipe tally length updated to subtract the known length L10, the desired stump 60 (at the estimated location plus the calculated error) is left protruding from the rig floor 16, which can again be coupled to the top drive 18 to repeat the removal procedure for another tubular 54.

The tubular management system 200 can coordinate retrieval of tubulars 54 from or delivery of tubulars 54 to the vertical storage area 80 or horizontal storage area 38. The pipe tally 312 can be pre-determined prior to the tubular string 58 being extended into the wellbore 15, with the tubular management system 200 coordinating collection of the desired tubulars 54 and in the desired order per the pipe tally 312 as the tubular string 58 is extended into the wellbore 15. The tubular management system 200 can also suggest substitutions for replacement tubulars 54 if one or more of the tubulars in the pipe tally are determined (e.g., by operators or the tubular management system 200) to be unacceptable (or soon to be unacceptable) for continued use.

The tubular management system 200 (via sensors 70, predictive use models, machine learning, or input from operators), can determine and log maximum applied torques, maximum bending forces applied, usage parameters such as time in service, etc. for each tubular 54 and store these parameters in the database 169 in the unique data record associated with the unique record ID of the particular tubular 54.

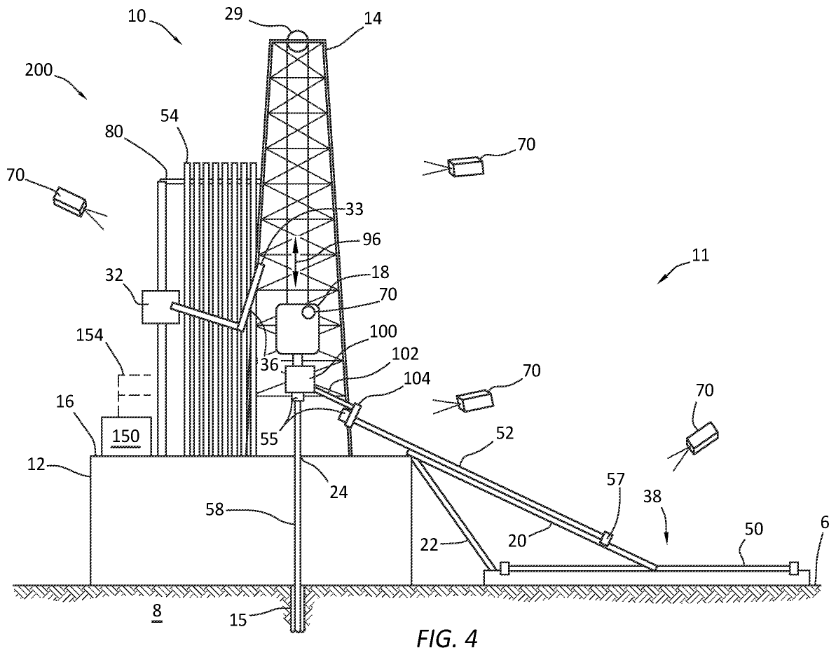

FIG. 4 shows the top drive 18 lowered (arrows 96) to extend the tubular string 58 further into the wellbore 15. As the top drive 18 is being lowered, the link pair 102 of the tubular running tool 100 can be rotated to a position where the elevator clamp 104 can be secured to the top (e.g., box end 55) of the next tubular 52 when the top drive 18 is at the desired lower position, which can be determined by the sensor 70 in the top drive 18. The vertical position of the top drive 18 can also be determined or verified by the imaging sensors 70 that can capture imagery of the top drive 18 and send the imagery to the rig controller 150 for processing. The imagery of the top drive 18 can be compared to position sensors 70 that independently determine (with the rig controller 150) an estimated position or location of the top drive 18. The imagery can also be used by the MLM 173 to determine a deviation of the top drive 18 from the estimated location. The deviation detected by the MLM 173 can be stored as a deviation parameter of the top drive 18 from the estimated location. Once the current tubular 54 is lowered to the desired location, the retention feature 71 in the rig floor 16 can engage the tubular string 58, and the tubular running tool 100 can disengage from the tubular 54 to allow the crown block 29 to raise the next tubular 52 (via the top drive 18 and tubular running tool 100 combination) to a height that allows the next tubular 52, 54 to be vertically positioned above the tubular string 58, which now includes the previously added tubular 54.

The stump 60 remains protruding from the rig floor 16 when the top drive 18 is lifted away from the rig floor 16 carrying the next tubular 54. An expected location of the box end 55 of the tubular string 58 can be calculated based on the pipe tally length 310, the known length L10 of the previously added tubular 54, and the vertical distance traveled by the top drive 18, which can be determined from the sensor(s) 70 on or in the top drive 18. Imagery from one or more imaging sensors 70 viewing the stump 60 can be provided to the MLM 173 to determine if the stump 60 deviates from the expected (or estimated) location. This deviation, if it is detected, can be stored in the error database 167 as a deviation parameter for the stump 60.

By detecting, via the MLM 173, deviations from the expected location of the box end 55, the tubular management system 200 can detect errors in the expected location, which can indicate equipment degradation such as slip wear, top drive 18 movement errors, errors in the length data associated with tubulars 54, as well as other errors. These errors (or deviation parameters) can be used by the pipe handlers (such as pipe handlers 30, 32, 34, top drive 18, iron roughneck 40, drill floor robot 26, tubular management system 200) to deviate from the expected location by the deviation parameter amount to interact with the tubulars or other equipment at their actual location so they do not waste time, such as hunting for the box end 55 when tripping in or out. The deviation parameters can be used by the rig controller 150 to determine the actual position of a tool joint. The rig controller 250 can determine the lengths of each portion of the tool joint (pin and box end tool joints) from the unique data stored in the unique data records database 169 based on the unique record ID of the tubular 54.

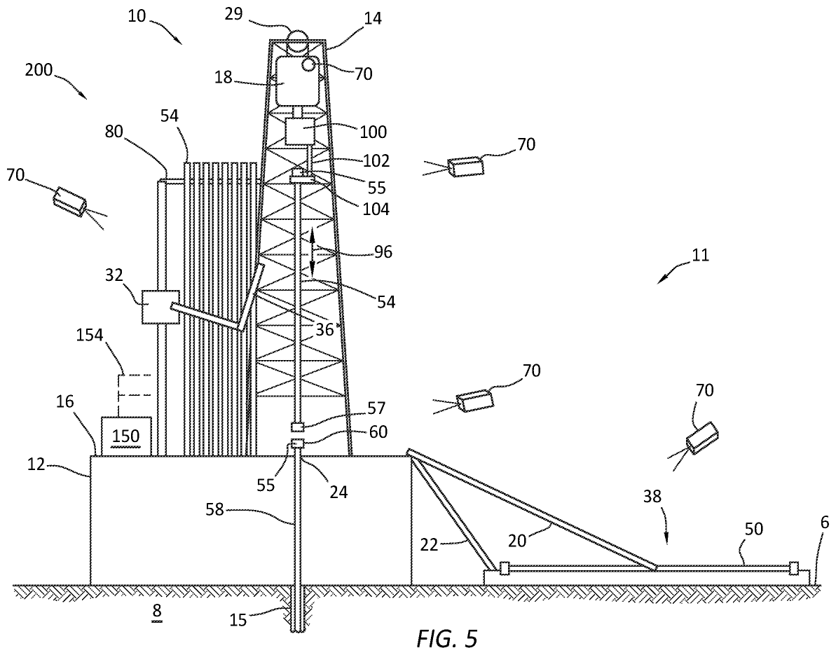

FIG. 5 shows the top drive 18 raised by the crown block 29 (arrows 96) and tubular running tool 100 supporting the tubular 54 before it is engaged with the tubular string 58. The elevator clamp 104 can engage the top end (e.g., box end 55) of the tubular 54 to suspend the tubular 54 from the tubular running tool 100 (or top drive 18).

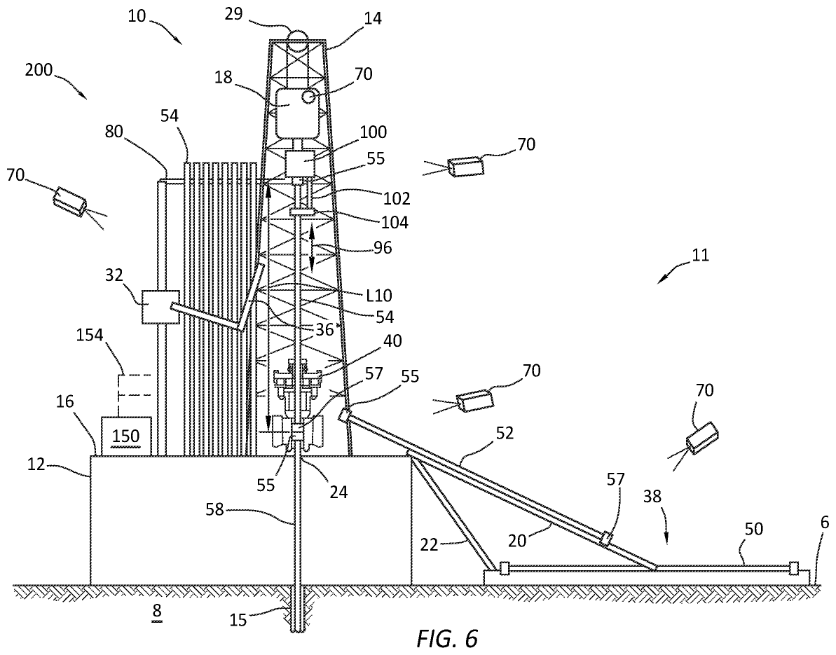

FIG. 6 shows the tubular running tool 100 lowered (arrows 96) to engage the lower end (e.g., pin end 57) of the tubular 54 with the top end (e.g., box end 55) of the tubular string 58 (i.e., stump 60) and thread the two ends together to connect the tubular 54 to the tubular string 58. An iron roughneck 40 can be used to make the connection between the tubular 54 and the tubular string 58. The pipe tally length 310 can be updated to include the new tubular 54 when the top drive 18 disengages from the tubular string 58 and engages with the next tubular 52, 54 to hoist it to the vertically aligned position above the tubular string 58. Alternatively, the pipe tally length 310 can be updated by adding the known length L10 of the next tubular 54 to the pipe tally length 310 at any time from when the top drive 18 first engages the next tubular 54 to when the next tubular 54 is connected to the tubular string 58 and lowered into the wellbore 15 leaving a stump 60 protruding above the rig floor 16.

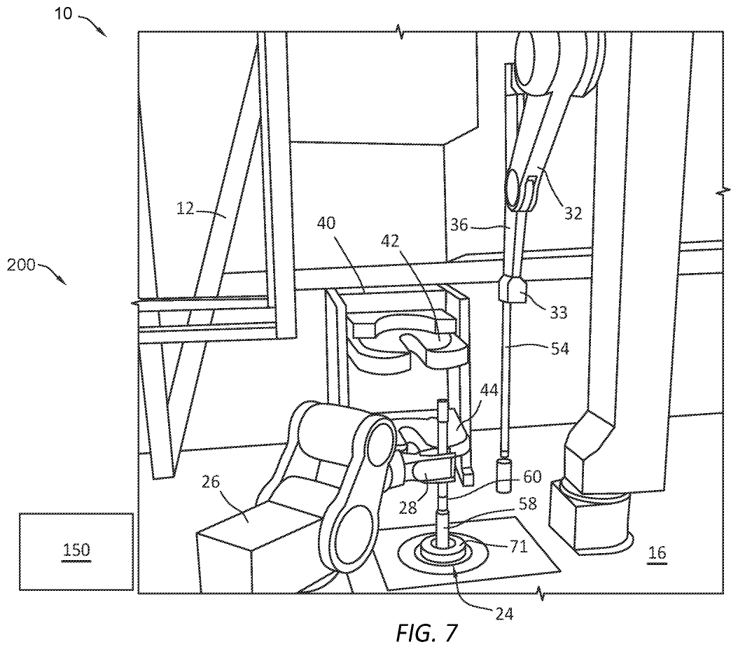

FIG. 7 is a representative perspective view of various rig equipment on a rig 10. The rig equipment on the rig floor 16 can be used in performing subterranean operations (e.g., drilling a wellbore, producing fluids from a wellbore, treating a wellbore, completing a wellbore, killing a wellbore, etc.). The rig equipment can include a drill floor robot 26 that can interact with the tubular string 58 by attaching/removing tools at the top of the tubular string 58 via an end effector 28 (e.g., a gripper). An iron roughneck 40 can be used to make/break a connection in the tubular string 58 using the upper tong 42 and the lower tong 44 to torque/untorque the connection. A pipe handler 32 with an arm 36 and an end effector 33 (e.g., a gripper) can manipulate tubulars 54 to and from the well center 24 for connecting to or removing from the tubular string 58. The pipe handler 32 can manipulate the tubular 54 between storage locations and the well center 24.

When tripping the tubular string 58 into the wellbore 15, tubulars 54 can be retrieved from storage locations (e.g., horizontal storage, vertical storage, mouse hole, etc.), placed at well center 24, transferred from the pipe handler 32 to a top drive 18 (not shown), and extended into the wellbore 15 through the retention feature 71 at the well center 24. When the top drive 18 has extended the tubular 54 (now part of the tubular string 58) into the wellbore a desired distance (preferably with a stump 60 of the tubular string 58 protruding from the retention feature 71), then the retention feature 71 can be activated to engage the tubular string 58. A rig controller 150 (or operator) can then transfer the weight of the tubular string 58 from the top drive 18 to the retention feature 71, were the retention feature 71 is holding the entire weight of the tubular string 58 as it extends into the wellbore 15. With the retention feature 71 holding the tubular string 58, the top drive 18 can move up and out of the way to allow the pipe handler 32 to present the next tubular 54 to the well center 24 and thread the tubular 54 into the box end 55 of the tubular string 58.

The iron roughneck 40 can then torque the new connection. The top drive 18 can then engage the top end of the newly added tubular 54 and the rig controller 150 (or other controller) can transfer the weight of the tubular string 58 from the retention feature 71 to the top drive 18. The top drive 18 can then extend the tubular string 58 into the wellbore 15 a desired distance to again leave a stump 60 of the tubular string 58 sticking out of the retention feature 71. This desired distance can be determined by the known length of the tubular 54 being added to the tubular string 58. The rig controller 150 can retrieve the known length from the unique data records database 169 based on the unique record ID of the tubular 54. When the top drive 18 disengages from the tubular string 58 leaving the stump 60, imaging sensors 70 can collect imagery of the box end 55 of the tubular string 58 and transfer the imagery to the MLM 173 which can determine a deviation from an expected location of the box end 55 of the tubular string 58. This process is repeated until the desired length of the tubular string 58 is extended into the wellbore 15.

When tripping the tubular string 58 out of the wellbore, tubulars 54 can be removed from the tubular string 58 at well center 24 and transferred to storage locations (e.g., horizontal storage, vertical storage, mouse hole, etc.). The top drive 18 can raise the tubular string 58 from the wellbore 15 a desired distance such that a tubular 54 is above the retention feature 71. The desired distance can be the distance required to allow a stump 60 of the tubular string 58 to remain protruding from the retention feature 71 when the tubular 54 is removed from the tubular string 58. When the top drive 18 has raised the tubular string 58 from the wellbore 15, the desired distance, the rig controller 150 can transfer the weight of the tubular string 58 from the top drive to the retention feature 71. The iron roughneck 40 can untorque the connection, then the pipe handler 32 can unthread the connection, thereby releasing the tubular 54 from the tubular string 58. The pipe handler 32 can then transport the tubular 54 to a storage location. The top drive 18 can then move down to engage the top of the tubular string 58 and again raise the tubular string 58 out of the wellbore the desired distance.

This desired distance can be determined by the known length L10 of the tubular 54 being added to the tubular string 58. The rig controller 150 can retrieve the known length L10 from the unique data records database 169 based on the unique record ID of the particular tubular 54. When the tubular 54 disengages from the tubular string 58 leaving the stump 60, imaging sensors 70 can collect imagery of the box end 55 of the tubular string 58 and transfer the imagery to the MLM 173 which can determine a deviation from an expected location of the box end 55 of the tubular string 58. This process is repeated until a desired portion of the tubular string 58 is removed from the wellbore 15.

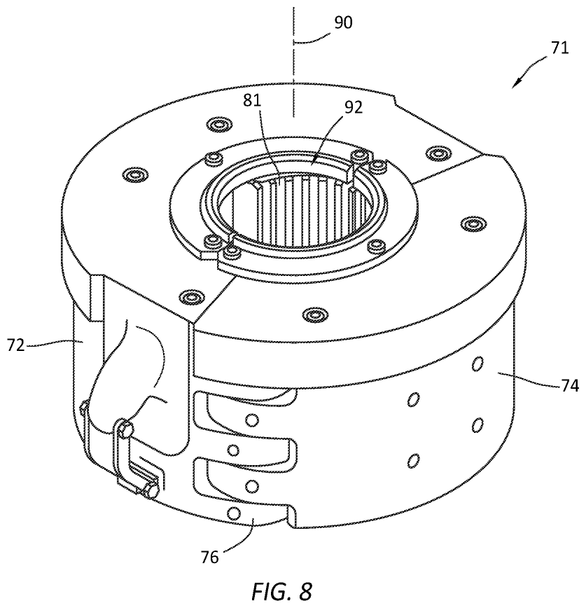

FIG. 8 is a representative perspective view of an example of a retention feature 71 that can be used during subterranean operations. The retention feature 71 can include a plurality of grippers 81 that surround a passage 92 that can extend through the retention feature 71 along an axis 90. The grippers 81 can be supported and activated by a housing of the retention feature 71. The housing can include housing segments 72, 74 that are linked together at hinge plates 76.

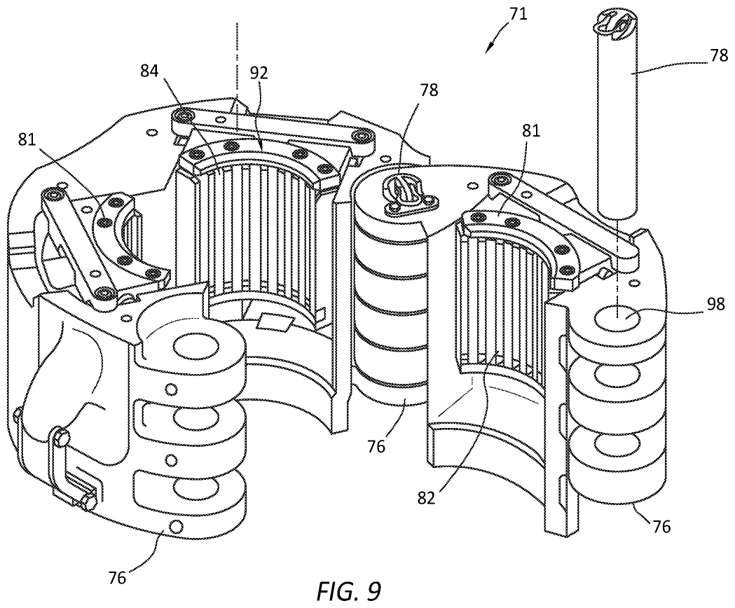

FIG. 9 is a representative perspective view of the example the retention feature 71 shown in FIG. 8 with the housing of the retention feature 71 opened to reveal grippers 81. The housing segments 72, 74 can have hinge plates 76 at each end. The hinge plates 76 of the housing segments 72, 74 can interleave each other such that a pin 78 can be inserted through holes 98 in each of the hinge plates 76 for each housing segments 72, 74. The grippers 81 are positioned around the passage 92, through which a tubular string 58 can be extended. When the housing is closed (as in FIG. 8) the grippers 81 can be radially extended inwardly to engage the tubular string 58 via an engagement surface 82 of each gripper 81. Retracting the grippers 81 radially away from the axis 90 can release (or disengage) the tubular string 58 and allow axial movement of the tubular string 58 through the retention feature 71. By continually transferring the weight of the tubular string to/from the retention feature 71, the engagement surface 82 of each gripper 81 continues to wear. At some point the engagement surfaces 82 can no longer engage the tubular string 58 with enough force to prevent axial movement (and possibly horizontal movement or a combination of both) of the tubular string 58.

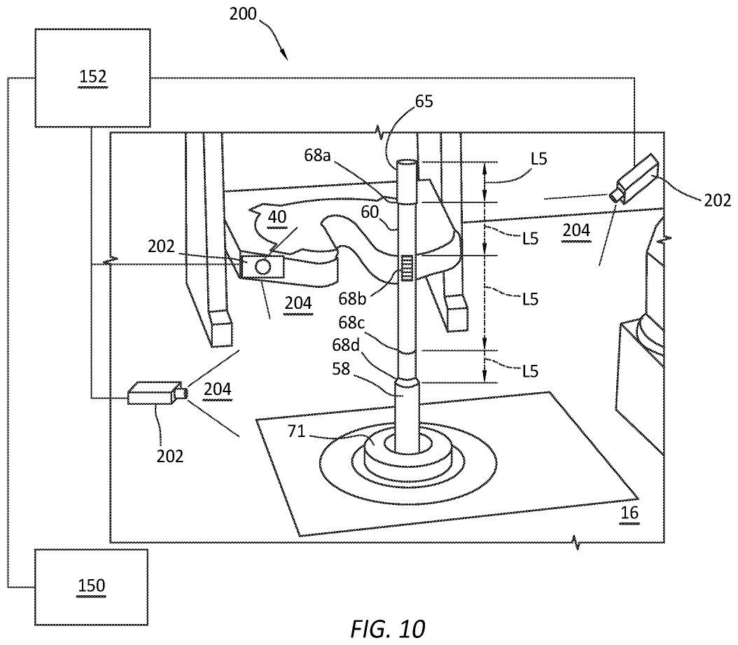

FIG. 10 is a representative functional block diagram of at least a portion of a tubular management system 200 that can be used to detect and calculate errors in a pipe tally length 310, which can possibly indicate wear in a retention feature 71 or other errors as stated above. More particularly, the tubular management system 200 can include one or more imaging sensors 202 that are communicatively coupled to the processor 152. Each of the imaging sensors 202 can have a field of interest 204 that allows captured imagery to include the stump 60 of the tubular string 58 and at least one detectable feature (e.g., detectable features 68a-d). The imaging sensors 202 can be positioned on the rig 10 at any location, such as on the derrick 14, on rig equipment (e.g., the iron roughneck 40, drill floor robot 26, etc.), or other structures on the rig 10. An imaging sensor 202 can capture imagery that includes one or more detectable features 68a-d and can communicate the imagery to a processor for image processing.

These detectable features 68a-d can be anything on the stump 60 that is consistent between tubulars 54 and can be recognized by the tubular management system 200. The detectable features 68a-d are generally spaced away from the top 65 of the tubular string 58 by a distance L5, which can be recorded in the unique data record associated with the unique record ID for the particular tubular 54. Distances L5 can vary from one tubular 54 to another, and these differences can be recorded in the unique data record for each tubular 54.

For examples, the detectable feature 68a can be the bottom edge of the box end of the connector (or casing collar) positioned at the top of the stump 60. The detectable feature 68b can be a pattern (e.g., bar code, Q-code, colored pattern, rings around the tubular, physical features, protrusions, recesses, etc.) on the stump 60. The detectable feature 68c can be one or more rings around the stump 60 (e.g., colored band, physical indention, physical protrusion, etc.). The detectable feature 68d can be a location on the stump 60 that is a transition between a smaller outer diameter to a larger outer diameter. Any of these detectable features 68a-d can be used by the MLM 173 in the tubular management system 200 to determine deviations from an expected location of the detectable features 68a-d.

The processor 152 can be communicatively coupled to the rig controller 150 for communicating the imagery from the imaging sensors 202 to the rig controller 150 that can analyze the imagery to determine a deviation parameter for the detectable feature 68, which can at least be one of the indicated detectable features 68a-d. When the new tubular 54 is attached to the tubular string 58 and lowered into the wellbore 15, the rig controller 150 can determine an estimated location of the detectable feature 68 above the rig floor 16 based on the known length L10 and the distance L5′ of an adjacent tubular 54 in the tubular string 58 and detect a deviation of the detectable feature 68 from the estimated location of the detectable feature 68.

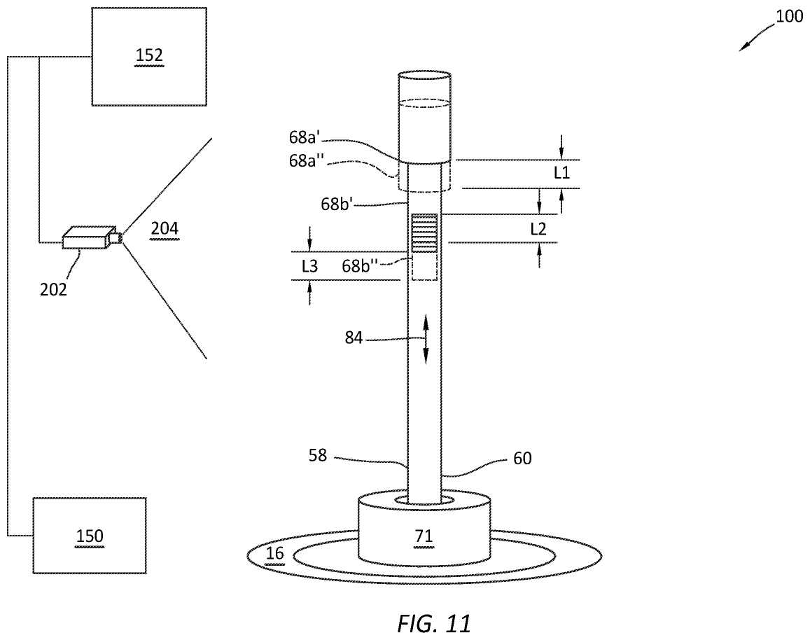

FIG. 11 is another representative functional block diagram of a tubular management system 200 that can be used to detect deviation parameters in the handling of tubulars 54 on the rig 10. The tubular management system 200 can capture imagery for at least one detectable feature (only detectable features 68a, 68b, are shown in FIG. 11). Processing performed by the rig controller 150 can determine an estimated location of the detectable feature 68a-b in the 3D space above the rig floor 16. The imaging sensors 202 can collect imagery of the detectable feature 68a-b, that can be used by the MLM 173 to determine a deviation from an estimated (or expected) location, such as an estimated location calculated by using the pipe tally length 310. An estimated (or expected) location can be calculated based on the known length L10 of the tubular 54 recently added to the tubular string 58 and on the vertical travel distance of the top drive 18 for tripping in or out of the wellbore.

By knowing the pipe tally length 310 and the location of the stump 60 before adding a tubular 54 to the tubular string 58, knowing the length L10 of the tubular 54, and knowing the vertical distance traveled by the top drive 18 to lower the tubular string 58, the rig controller 150 can determine the estimated location of the stump 60 or any detectable feature 68 after the tubular 54 has been extended into the wellbore 15 the desired distance to leave the desired stump 60 above the rig floor 16. By adding the known length L10 to the pipe tally length 310, and knowing the vertical distance traveled by the top drive 18 to lower the tubular string 58, the rig controller 150 can determine the estimated location of the detectable feature 68 on the stump 60 of the newly added tubular 54.

It should also be understood that the tubular management system 200 can also track the expected location of the detectable feature 68a-b as the tubular string 58 is lowered into the wellbore 15 or pulled out of the wellbore 15. As stated above, the deviation parameter (or calculated error) can be calculated continuously or periodically or randomly at various time intervals as the as the tubular string 58 is lowered into the wellbore 15 or pulled out of the wellbore 15. The consistency of the deviation parameter (or calculated error) can indicate a confidence level in the value of the calculated error or deviation parameter, and the rig controller 150 can determine a confidence score for each (or for an aggregate) of the deviation parameters and the confidence score can be reported in real-time or recorded for later use.

By knowing the pipe tally length 310 and the location of the stump 60 before removing a tubular 54 from the tubular string 58, knowing the length L10 of the tubular 54, and knowing the vertical distance traveled by the top drive 18 to raise the tubular string 58, the rig controller 150 can determine the estimated location of the stump 60 or any detectable feature 68 after the tubular string 58 has been raised from the wellbore 15 the desired distance to leave the desired stump 60 above the rig floor 16 for the tubular string 58 when the tubular 54 is removed. By subtracting the known length L10 from the pipe tally length 310, and knowing the vertical distance traveled by the top drive 18 to raise the tubular string 58, the rig controller 150 can determine the estimated location of the detectable feature 68 on the stump 60 of the tubular string 58 after the tubular 54 is removed.

If the actual location of the detectable feature 68 varies from the estimated location by more than a pre-determined distance (or amount), this can indicate an error in the pipe tally length 310 or an error in the pipe handling equipment (e.g., a retention feature 71, pipe handlers 30, 32, 34, top drive 18, iron roughneck 40, drill floor robot 26, etc.) or an error in the tubular management system 200, such as where a different tubular 54 is used instead of a desired tubular 54 or where a tubular 54 has different known length L10 than the unique data record indicates.

The known length L10 of the tubular 54 and the detected vertical distance traveled by the top drive 18 can be used to calculate the estimated location of the detectable feature. The vertical distance L1, L2, or L3 between the estimated location and the actual location of the detectable feature 68 can illustrate a deviation from the estimated location of the detectable feature 68, which can be detected by the MLM 173 by image processing of images of the detectable feature 68 or the stump 60. The pipe handlers can then use the detected deviation to accommodate for the deviation from the estimated location, such as when a different tubular 54 is used, and detect errors in handling the tubulars 54 or detect errors in the database 169. If the deviation parameter is outside of an acceptable level, then the subterranean operation can be stopped to determine the cause of the deviation parameter (or error) and correct the problem before damage in incurred by the rig equipment, including, pipe handlers, tubulars, etc. For example, if an error in the location of the stump 60 is detected and the error is larger than is acceptable, then subterranean operations can be halted to allow for maintenance operations to correct the problem. If the processor 152 detects an unacceptable amount of deviation, then it can communicate an alarm (or action request) to the rig controller 150 which can take appropriate measures to ensure safe operation of the rig equipment, and/or the rig controller 150 can alert an operator who can initiate corrective actions.

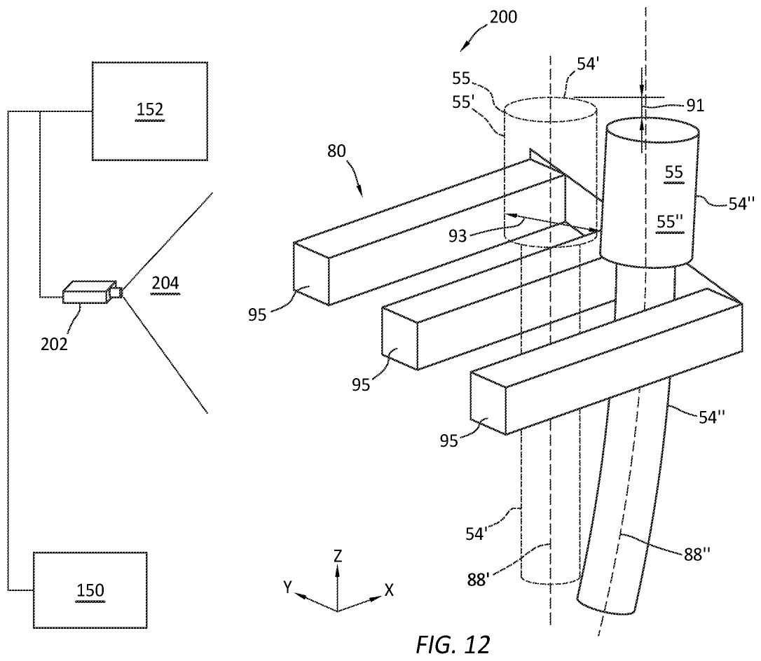

FIG. 12 is another representative functional block diagram of a tubular management system 200 that can be used to detect deviations in the handling of tubulars 54 on the rig 10. This figure shows a tubular 54 that is released from a pipe handler at the estimated location 54′ (dashed lines) between fingers 95 of a fingerboard 80, where the pipe handler or other sensors 70 can provide the location information for the estimated location 54′. The tubular management system 200 can include one or more imaging sensors 202, each with a field of interest 204. The imaging sensors 202 can collect imagery of the tubulars 54 in the vertical storage area 80, transfer the imagery to the MLM 173, which can detect a deviation from the estimated location (shown as an actual location 54″ of the tubular 54) after the tubular 54 has been released from the pipe handler and comes to rest in the vertical storage area 80. When the tubular 54 is released from the pipe handler, the tubular 54 can lean to one side (arrows 93) which can cause the tubular 54 to bend slightly as seen in the somewhat exaggerated deviation of the longitudinal axis from the location 88′ to the location 88″.

The tubular management system 200, e.g., via imaging sensors 202, can detect, via, the movement of the tubular 54 (arrows 93) and the reduction in height (arrows 91) as well as the final resting location of the tubular 54 in the X-Y-Z coordinate 3D space by communicating the imagery from the imaging sensors 202 to the rig controller 150 and analyzing the imagery, via the MLM 173. In this example, the change in the linearity, the height, and the 3D location of the tubular 54, can be seen as errors or deviations from the estimated location, which has resulted in the actual location of the tubular 54. The deviation parameters can be stored in the error database 167, which is separate from the unique data records database 169. The errors database 167 can also store the error or deviation from the location 55′ of the box end 55 of the tubular 54, to the location 55″ of the box end 55. Therefore, if a pipe handler needed to engage a shoulder of the box end 55 to transport the tubular 54 from the fingerboard 80, then the rig controller 150 can collect the estimated location 55′ of the box end 55 from the unique data records database 169 and collect the deviation parameters from of the estimated location 55′ from the error database 167 (i.e., 55″), and then provide the pipe handler with the deviation from the estimated location 55′. In this way, the pipe handler can be controlled to seek the actual location of an object or piece of rig equipment and based on a deviation from the estimated location.

### VARIOUS EMBODIMENTS

### Embodiment 1

A method for conducting subterranean operations comprising:
engaging a tubular with a pipe handler;
moving the tubular with the pipe handler to a new location;
disengaging from the tubular at the new location;
determining, via a rig controller, an estimated location of the tubular based on the new location at which the pipe handler disengaged from the tubular; and
determining, via a machine learning module of the rig controller, a deviation parameter of the tubular by determining a deviation from the estimated location based on processing collected images from one or more imaging sensors that contain the tubular.

### Embodiment 2

The method of embodiment 1, further comprising:
storing the deviation parameter in a unique entry in an error database, wherein the unique entry is associated with a unique record identification (ID) of the tubular; and
storing the estimated location in a tubular database in a unique data record entry that is associated with the unique record ID of the tubular.

### Embodiment 3

The method of embodiment 2, further comprising:
retrieving, via the rig controller and based on the unique record ID, the deviation parameter from the error database and the estimated location from the tubular database; and
controlling the pipe handler to engage the tubular based on the estimated location and the deviation parameter.

### Embodiment 4

The method of embodiment 1, further comprising initiating a corrective action if the deviation parameter is above a pre-determined value.

### Embodiment 5

The method of embodiment 1, wherein the new location is a resulting location when the tubular is connected to a tubular string at well center and is lowered into a wellbore, wherein the pipe handler is a top drive.

### Embodiment 6

The method of embodiment 5, wherein the tubular string is at a known location prior to connection of the tubular to the tubular string, wherein after connection of the tubular to the tubular string, lowering the tubular string, via the top drive, a pre-determined distance; and determining the estimated location of the tubular by adding a known length of the tubular to the known location of the tubular string and subtracting the pre-determined distance.

### Embodiment 7

The method of embodiment 6, wherein the deviation parameter indicates slippage of the tubular string after the top drive hands off the tubular string to a retention feature at well center on a rig floor.

### Embodiment 8

The method of embodiment 1, wherein the new location is an estimated location where the tubular is disengaged from the pipe handler in a vertical storage area.

### Embodiment 9

The method of embodiment 8, wherein the pipe handler communicates the estimated location to the rig controller, the method further comprising:
determining, via the machine learning module processing the collected images, the deviation from the estimated location of the tubular in the vertical storage area;
storing the deviation in an error database as a deviation parameter; and
controlling, via the rig controller, the pipe handler to engage the tubular based on the deviation parameter.

### Embodiment 10

The method of embodiment 9, wherein the deviation parameter comprises a deviation in a linearity of the tubular from the estimated location.

### Embodiment 11

A method for conducting a subterranean operation comprising:
retrieving a known length of a tubular from a unique data record in a first database, wherein the unique data record is associated with a unique record identification (ID) of the tubular;
detecting, via an imaging sensor, a location of a first detectable feature of a tubular string;
connecting the tubular to the tubular string;
lowering the tubular string along with the tubular a pre-determined distance into a wellbore;
determining, via a rig controller, an estimated location of a second detectable feature of the tubular by adding the known length to the location of the first detectable feature and subtracting the pre-determined distance;
detecting, via a machine learning module, a deviation of the second detectable feature from the estimated location; and
storing the deviation as a deviation parameter in a second database associated with the unique record ID of the tubular.

### Embodiment 12

The method of embodiment 11, wherein the imaging sensor is a laser imaging detection and ranging (LiDAR) sensor.

### Embodiment 13

The method of embodiment 11, wherein the imaging sensor is a time-of-flight camera.

### Embodiment 14

The method of embodiment 11, further comprising:
storing the estimated location of the second detectable feature in the first database.

### Embodiment 15

The method of embodiment 14, further comprising:
retrieving the estimated location of the second detectable feature from the first database;
retrieving the deviation parameter from the second database; and
controlling, via the rig controller, a pipe handler to engage the tubular based on the estimated location of the second detectable feature and the deviation parameter.

### Embodiment 16

The method of embodiment 11, further comprising:
adding the tubular to a pipe tally and adding the known length to a pipe tally length when a pipe handler engages the tubular to add the tubular to the tubular string.

### Embodiment 17

The method of embodiment 11, wherein the first database comprises characteristics for each of a plurality of tubulars, the characteristics being associated with a unique record ID for each of the plurality of tubulars.

### Embodiment 18

The method of embodiment 17, wherein the characteristics comprise at least one of:
three-dimensional (3D) location and 3D orientation;
inner and outer diameters;
weight;
known length;
location of one or more detectable features;
thread lengths;
tool joint lengths;
linearity; or
combinations thereof.

### Embodiment 19

A method for conducting a subterranean operation comprising:
retrieving a known length of a first tubular from a unique data record in a first database, wherein the unique data record is associated with a unique record identification (ID) of the first tubular;
detecting, via an imaging sensor, a location of a first detectable feature of the first tubular;
raising a tubular string a pre-determined distance out of a wellbore, wherein the first tubular is connected at a top of the tubular string;
determining, via a rig controller, an estimated location of a second detectable feature of the tubular string by adding the pre-determined distance to the location of the first detectable feature and subtracting the known length;
disconnecting the first tubular from the tubular string;
detecting, via a machine learning module, a deviation from the estimated location of the second detectable feature; and
storing the deviation as a deviation parameter in a second database associated with a unique record ID of a second tubular that is connected at the top of the tubular string after the first tubular is removed from the tubular string.

### Embodiment 20

The method of embodiment 19, wherein the imaging sensor is a laser imaging detection and ranging (LiDAR) sensor.

### Embodiment 21

The method of embodiment 19, wherein the imaging sensor is a time-of-flight camera.

### Embodiment 22

The method of embodiment 19, further comprising:
storing the estimated location of the second detectable feature in the first database.

### Embodiment 23

The method of embodiment 22, further comprising:
retrieving the estimated location of the second detectable feature from the first database;
retrieving the deviation parameter from the second database; and
controlling, via the rig controller, a pipe handler to engage the second tubular based on the estimated location of the second detectable feature and the deviation parameter.

### Embodiment 24

The method of embodiment 19, further comprising:
subtracting the first tubular from a pipe tally and subtracting the known length from a pipe tally length when a pipe handler removes the first tubular from the tubular string.

### Embodiment 25

The method of embodiment 19, wherein the first database comprises characteristics for each of a plurality of tubulars, the characteristics being associated with a unique record ID for each of the plurality of tubulars.

### Embodiment 26

The method of embodiment 25, wherein the characteristics comprise at least one of:
three-dimensional (3D) location and 3D orientation;
inner and outer diameters;
weight;
known length;
location of one or more detectable features;
thread lengths;
tool joint lengths;
linearity; or
combinations thereof.

### Embodiment 27

The method of embodiment 1, further comprising determining, via the machine learning module, a confidence score for the deviation parameter, wherein the confidence score represents a confidence in an accuracy of the deviation parameter.

### Embodiment 28

The method of embodiment 1, further comprising determining, via the rig controller, the estimated location of the tubular while the tubular is being moved by the pipe handler.

### Embodiment 29

The method of embodiment 28, further comprising determining a plurality of deviation parameters as the tubular is being moved based on a plurality of estimated locations on a path along which the tubular is being moved; and determining, via the machine learning module, a plurality of deviation parameters of the tubular by determining a deviation from each of the plurality of estimated locations based on processing collected images from one or more imaging sensors that contain the tubular.

### Embodiment 30

The method of embodiment 29, further comprising determining, via the machine learning module, a confidence score for each of the plurality of deviation parameters, wherein each of the confidence scores represent a confidence in an accuracy of the corresponding one of the plurality of deviation parameters.

While the present disclosure may be susceptible to various modifications and alternative forms, specific embodiments have been shown by way of example in the drawings and tables and have been described in detail herein. However, it should be understood that the embodiments are not intended to be limited to the particular forms disclosed. Rather, the disclosure is to cover all modifications, equivalents, and alternatives falling within the spirit and scope of the disclosure as defined by the following appended claims. Further, although individual embodiments are discussed herein, the disclosure is intended to cover all combinations of these embodiments.

What is claimed is:

1. A method for conducting subterranean operations comprising:
engaging a tubular with a pipe handler;
moving the tubular with the pipe handler to a new location;
disengaging from the tubular at the new location;
determining, via a rig controller, an estimated location of the tubular based on the new location at which the pipe handler disengaged from the tubular; and
determining, via a machine learning module of the rig controller, a deviation parameter of the tubular by determining a deviation from the estimated location based on processing collected images from one or more imaging sensors that contain the tubular.

2. The method of claim 1, further comprising determining, via the machine learning module, a confidence score for the deviation parameter, wherein the confidence score represents a confidence in an accuracy of the deviation parameter.

3. The method of claim 1, further comprising determining, via the rig controller, the estimated location of the tubular while the tubular is being moved by the pipe handler.

4. The method of claim 3, further comprising:
determining a plurality of deviation parameters as the tubular is being moved based on a plurality of estimated locations on a path along which the tubular is being moved; and
determining, via the machine learning module, a plurality of deviation parameters of the tubular by determining a deviation from each of the plurality of estimated locations based on processing collected images from one or more imaging sensors that contain the tubular.

5. The method of claim 4, further comprising determining, via the machine learning module, a confidence score for each of the plurality of deviation parameters, wherein each of the confidence scores represent a confidence in an accuracy of the corresponding one of the plurality of deviation parameters.

6. The method of claim 5, wherein each of the plurality of deviation parameters is substantially equal to the other ones of the plurality of deviation parameters, thereby indicating a high confidence score for each of the plurality of deviation parameters.

7. The method of claim 1, further comprising:
storing the deviation parameter in a unique entry in an error database, wherein the unique entry is associated with a unique record identification (ID) of the tubular; and
storing the estimated location in a tubular database in a unique data record entry that is associated with the unique record ID of the tubular.

8. The method of claim 7, further comprising:
retrieving, via the rig controller and based on the unique record ID, the deviation parameter from the error database and the estimated location from the tubular database; and
controlling the pipe handler to engage the tubular based on the estimated location and the deviation parameter.

9. The method of claim 1, wherein the new location is a resulting location when the tubular is connected to a tubular string at well center and is lowered into a wellbore, wherein the pipe handler is a top drive.

10. The method of claim 9, wherein the tubular string is at a known location prior to connection of the tubular to the tubular string, wherein after connection of the tubular to the tubular string, lowering the tubular string, via the top drive, a pre-determined distance; and determining the estimated location of the tubular by adding a known length of the tubular to the known location of the tubular string and subtracting the pre-determined distance.

11. The method of claim 10, wherein the deviation parameter indicates slippage of the tubular string after the top drive hands off the tubular string to a retention feature at well center on a rig floor.

12. The method of claim 1, wherein the new location is an estimated location where the tubular is disengaged from the pipe handler in a vertical storage area.

13. The method of claim 12, wherein the pipe handler communicates the estimated location to the rig controller, the method further comprising:
determining, via the machine learning module processing the collected images, the deviation from the estimated location of the tubular in the vertical storage area;
storing the deviation in an error database as a deviation parameter; and
controlling, via the rig controller, the pipe handler to engage the tubular based on the deviation parameter.

14. The method of claim 13, wherein the deviation parameter comprises a deviation in a linearity of the tubular from the estimated location.

15. A method for conducting a subterranean operation comprising:
retrieving a known length of a tubular from a unique data record in a first database, wherein the unique data record is associated with a unique record identification (ID) of the tubular;
detecting, via an imaging sensor, a location of a first detectable feature of a tubular string;
connecting the tubular to the tubular string;
lowering the tubular string along with the tubular a pre-determined distance into a wellbore;
determining, via a rig controller, an estimated location of a second detectable feature of the tubular by adding the known length to the location of the first detectable feature and subtracting the pre-determined distance;
detecting, via a machine learning module, a deviation of the second detectable feature from the estimated location; and
storing the deviation as a deviation parameter in a second database associated with the unique record ID of the tubular.

16. The method of claim 15, further comprising:
storing the estimated location of the second detectable feature in the first database;
retrieving the estimated location of the second detectable feature from the first database;
retrieving the deviation parameter from the second database; and
controlling, via the rig controller, a pipe handler to engage the tubular based on the estimated location of the second detectable feature and the deviation parameter.

17. The method of claim 15, further comprising:
adding the tubular to a pipe tally and adding the known length to a pipe tally length when a pipe handler engages the tubular to add the tubular to the tubular string.

18. A method for conducting a subterranean operation comprising:
retrieving a known length of a first tubular from a unique data record in a first database, wherein the unique data record is associated with a unique record identification (ID) of the first tubular;
detecting, via an imaging sensor, a location of a first detectable feature of the first tubular;
raising a tubular string a pre-determined distance out of a wellbore, wherein the first tubular is connected at a top of the tubular string;
determining, via a rig controller, an estimated location of a second detectable feature of the tubular string by adding the pre-determined distance to the location of the first detectable feature and subtracting the known length;
disconnecting the first tubular from the tubular string;
detecting, via a machine learning module, a deviation from the estimated location of the second detectable feature; and
storing the deviation as a deviation parameter in a second database associated with a unique record ID of a second tubular that is connected at the top of the tubular string after the first tubular is removed from the tubular string.

19. The method of claim 18, further comprising:
storing the estimated location of the second detectable feature in the first database;
retrieving the estimated location of the second detectable feature from the first database;
retrieving the deviation parameter from the second database; and
controlling, via the rig controller, a pipe handler to engage the second tubular based on the estimated location of the second detectable feature and the deviation parameter.

20. The method of claim 18, further comprising:
subtracting the first tubular from a pipe tally and subtracting the known length from a pipe tally length when a pipe handler removes the first tubular from the tubular string.
